(19) United States
(12) Patent Application Publication
(10) Pub. No.: US 2015/0136703 A1
(43) Pub. Date: May 21, 2015

(54) TITANIUM-IMPREGNATED CARBON NANOTUBES FOR SELENIUM REMOVAL

(71) Applicant: KING FAHD UNIVERSITY OF PETROLEUM AND MINERALS, DHAHRAN (SA)

(72) Inventors: OMER YAHYA BAKATHER, DHAHRAN (SA); MUATAZ ALI ATIEH, DHAHRAN (SA)

(73) Assignee: KING FAHD UNIVERSITY OF PETROLEUM AND MINERALS, DHAHRAN (SA)

(21) Appl. No.: 14/084,475

(22) Filed: Nov. 19, 2013

(51) Int. Cl. C02F 1/28; B01J 20/28

(52) U.S. Cl. CPC C02F 1/288; B01J 20/28028; C02F 2305/00; C02F 2101/106
USPC 210/663; 210/679

(57) ABSTRACT

The titanium-impregnated carbon nanotubes for selenium removal provide a composition for removing or reducing the levels of selenium in water. The titanium-impregnated carbon nanotubes comprise a range of about 5 wt % titanium to 20 wt % titanium. A process for removing selenium from water includes the steps of placing the titanium-impregnated carbon nanotubes into contact with the water and adjusting the pH value of the water.

### BACKGROUND OF THE INVENTION

1. Field of the Invention

The present invention relates to water purification compositions and processes, and particularly to titanium-impregnated carbon nanotubes for selenium removal from water.

2. Description of the Related Art

Selenium can be considered a nutrient for humans and animals when present in trace quantities. However, selenium can also be toxic to humans and animals in larger concentrations. Relatively toxic amounts of selenium can contaminate water in a number of ways, such as through the weathering of natural rock, or through manufacturing operations. Types of manufacturing operations that can lead to selenium contamination include the manufacturing of pigmented glass, lubricants, or rubber, among others. Different techniques have been investigated to eliminate or reduce selenium levels in water, including reverse osmosis and adding adsorbents, such as activated charcoal, to the water.

Nanotubes, particularly carbon nanotubes, have attracted considerable research interest because of their mechanical-electrical properties, relatively higher chemical stability, and relatively larger specific area. Further, multi-walled carbon nanotubes have been previously used in removing metal ions, such as lead, copper, cadmium, silver, and nickel, from water.

Thus, titanium-impregnated carbon nanotubes for selenium removal solving the aforementioned problems is desired.

### SUMMARY OF THE INVENTION

The titanium-impregnated carbon nanotubes for selenium removal provide a composition for removing or reducing the levels of selenium in water. The titanium-impregnated carbon nanotubes comprise a range of about 5 wt % titanium to 20 wt % titanium. A process for removing selenium from water includes the steps of placing the titanium-impregnated carbon nanotubes into contact with the water and adjusting the pH value of the water.

These and other features of the present invention will become readily apparent upon further review of the following specification and drawings.

### BRIEF DESCRIPTION OF THE DRAWINGS

FIG. 1 is a plot of selenium removal percentage as a function of pH for titanium-impregnated carbon nanotubes for selenium removal according to the present invention where the nanocomposite has 10 weight % titanium.

FIG. 2 is a plot of selenium removal percentage as a function of pH for titanium-impregnated carbon nanotubes according to the present invention, showing a comparison of different weight percentages of titanium.

FIG. 3 is a plot of the equilibrium adsorption capacity of 10 wt % titanium-impregnated carbon nanotubes according to the present invention as a function of the initial concentration of selenium.

FIG. 4 is a plot of selenium removal percentage as a function of dosage of 10 wt % titanium-impregnated carbon nanotubes according to the present invention.

FIG. 5 is a plot of selenium removal percentage as a function of contact time of 10 wt % titanium-impregnated carbon nanotubes according to the present invention.

FIG. 6 is a plot showing that the removal of selenium from aqueous solution by 10 wt % titanium-impregnated carbon nanotubes according to the present invention exhibits second-order kinetics.

FIG. 7A is a plot of the Langmuir adsorption isotherm model for the adsorption of selenium from aqueous solution by 10 wt % titanium-impregnated carbon nanotubes according to the present invention.

FIG. 7B is a plot of the Freundlich adsorption isotherm model for the adsorption of selenium from aqueous solution by 10 wt % titanium-impregnated carbon nanotubes according to the present invention.

Similar reference characters denote corresponding features consistently throughout the attached drawings.

### DETAILED DESCRIPTION OF THE PREFERRED EMBODIMENTS

The titanium-impregnated carbon nanotubes for selenium removal are fabricated by impregnating multi-walled carbon nanotubes (MWCNTs) with titanium (Ti). The titanium-impregnated carbon nanotubes (Ti/CNTs) possess a relatively improved capacity to remove selenium from water. The following examples illustrate synthesis and testing of the titanium-impregnated carbon nanotubes for selenium removal.

Samples of the Ti/CNTs were synthesized as follows. About 0.25 grams of titanium isopropoxide was dissolved in about 200 milliliters (ml) of ethanol solution and mixed with about 4.75 g of MWCNTs to prepare carbon nanotubes impregnated with titanium nanoparticles having 5 weight (wt) % titanium (Ti-5/CNTs). The MWCNTs were prepared using a Floating Catalyst Chemical Vapor Deposition (FC-CVD) reactor.

The solution was mixed using an ultrasonic mixer for a time period of about 30 minutes. After mixing, the solution was placed inside a beaker, which was then placed inside a furnace at a temperature in a range of about 60° C. to 80 ° C. over the course of the night for evaporation of ethanol present in the solution, thus forming a product. After the overnight time period had elapsed, the product was placed inside an oven at about 350° C. for a period of about 3 hours for calcination. To prepare the samples having 10 wt % titanium (Ti-10/CNTs) and 20 wt % titanium (Ti-20/CNTs), the same procedures were followed but with different quantities, i.e., 0.5 g of titanium isopropoxide being mixed with 4.5 g of MWCNTs to yield Ti-10/CNTs samples (10 wt %) and 1 g of titanium isopropoxide being mixed with 4 g of MWCNTs to yield Ti-20/CNTs samples (20 wt %).

A stock solution of aqueous selenium was prepared by dissolving a proper amount of selenium dioxide (SeO₂) in deionized water, depending on the required concentration. The pH of the stock solution was adjusted by using either 0.1 M nitric acid or 0.1 M sodium hydroxide (NaOH). Lastly, buffer solutions were added to the stock solution to maintain the pH constant during the experiments. The materials used in preparing the Ti/CNTs samples and the stock solution of aqueous selenium were of analytical reagent grade and used as received without pretreatment. Titanium isopropoxide, SeO₂, nitric acid, sodium hydroxide, and ethanol were purchased from Sigma-Aldrich.

Batch mode adsorption experiments were conducted at room temperature to investigate the effect of pH of the Se solution, contact time, carbon nanotube dosages, and initial concentration of Se ions on the adsorption of Se ions. The experiments were carried out in volumetric flasks, and the initial and final concentrations of Se ions were analyzed by using Inductively Coupled Plasma (ICP).

The study of sorption kinetics can be used to express the adsorbate uptake rate as a function of the residence time of adsorbate at the solid/liquid interface. The pseudo-second-order rate equation can be expressed as:

$$\frac{t}{{q}_{t}} = \frac{1}{{K}_{2} {q}_{e}^{2}} + \frac{t}{{q}_{e}} \qquad ( 1 )$$

where qₑ is a sorption capacity (mg/g) at equilibrium, qₜ is a sorption capacity (mg/g) at time t, t is time (min), and K₂ is the rate constant of the pseudo-second-order sorption, given as g·mg⁻¹·min⁻¹.

Adsorption isotherm models are used to describe the distribution of the adsorbate species between liquid and adsorbent. The Langmuir and Freundlich isotherms were used to study the adsorption performance and to calculate the adsorption capacity for the adsorbent. The Langmuir adsorption isotherm is expressed as:

$${Q}_{e} = \frac{{q}_{m} {K}_{L} {C}_{e}}{1 + {K}_{L} {C}_{e}} , \qquad ( 2 )$$

where Qₑ is the amount adsorbed (mg/g), Cₑ is the equilibrium adsorbate concentration (mg/l), K_{L} is the Langmuir constant, and qₘ is the maximum adsorption capacity (mg of adsorbate adsorbed per g of adsorbent). Equation (2) can be linearized as follows:

$$\frac{{C}_{e}}{{Q}_{e}} = \frac{{C}_{e}}{{q}_{m}} + \frac{1}{{K}_{L} {q}_{m}} . \qquad ( 3 )$$

The Freundlich isotherm is expressed as:

Qₑ=K_{f}C₃^{1/n} (4)

Equation (3) can be linearized as follows:

$$log {Q}_{e} = \frac{1}{n} log {C}_{e} + log {K}_{f} , \qquad ( 5 )$$

where: K_{f} and n are the empirical constants that depend on several environmental factors.

The pH of the Se solution is a relatively important factor that can control the adsorption of Se ions on the adsorbent surface. When pH of the Se solution is lower than the Point of Zero Charge (pHPZC), the positive charge on the surface provides electrostatic interactions that are favorable for adsorbing anionic species.

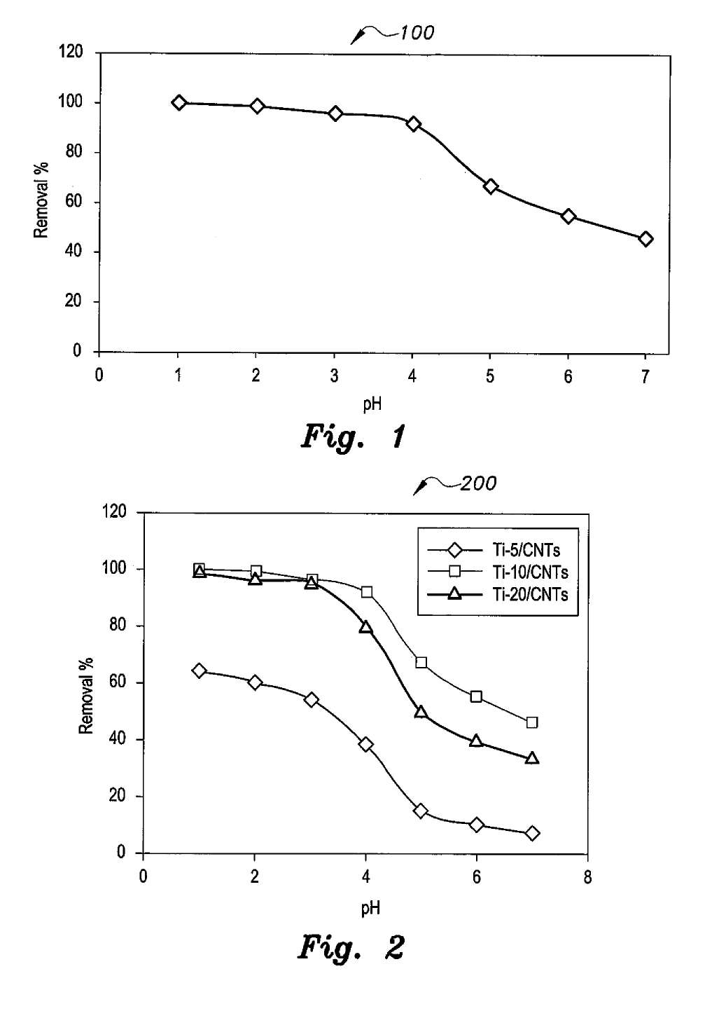

Referring to FIG. 1, the effects of pH on Se removal percentage was studied, and the results are shown as plot 100. The parameters of this experiment included an agitation speed of 150 revolutions per minute (rpm), a pH value of 6, a dosage of 10 milligrams (mg) of Ti-10/CNTs, a contact time of 6 hours (hrs), and an initial Se ions concentration of 1 part per million (ppm). As shown in FIG. 1, the adsorption of Se species increased when pH was decreased. The optimum pH value for adsorption of Se was in a range of about 1 to 4. These results can be explained by the positive charge of the adsorbent surface, which increases the electrical attraction between the surface and the Se species and the possibility of surface complexation of Se. The adsorption decreases when the pH of the solution increases due to an increase in the negative charge of the adsorbent surface and an increase in the competition of hydroxide (OH—) and Se ions on the site of the adsorbent.

Referring to FIG. 2, the effect of pH on Se removal percentage for various weight percentages of titanium in the nanocomposite are compared in plot 200. The parameters of this experiment included an agitation speed of 150 rpm, and dosages of 10 mg of Ti/CNTs at 5 wt % titanium (Ti-5/CNT), at 10 wt % titanium (Ti-10/CNT), and at 20 wt % titanium (Ti-20/CNT). Other parameters included a contact time of 6 hrs, and an initial Se ion concentration of 1 ppm. This experiment was conducted initially with pure carbon nanotubes (CNTs) without Ti being impregnated. Although not shown in FIG. 2, these pure CNTs showed poor adsorption of Se, displaying an adsorption of about 1% Se removal at pH values of 1 and 2. Further, the pure CNTs showed 0% Se removal at pH values greater than 2.

As shown in plot 200 of FIG. 2, impregnating CNTs with Ti noticeably improved the Se removal performance. When the percentage of Ti being impregnated was increased, the adsorption of Se increased as well. Plot 200 shows that the optimum percentage of Ti being impregnated for Se removal was at 10 wt % titanium, in comparison to Ti-5/CNTs and Ti-20/CNTs. Above 10 wt %, increasing the percentage of titanium produces no further increase in selenium removal. Increasing the adsorption of the Se ions by increasing the proportion of titanium can be explained by the increase of the positive charge on the CNTs surface, since Ti enhances the electrostatic interactions between the Se species and the CNTs' surface. The Ti-10/CNTs embodiment was selected for further analysis of the effects of initial Se ions concentration, Ti/CNT dosages, contact time, kinetics, and isotherm models.

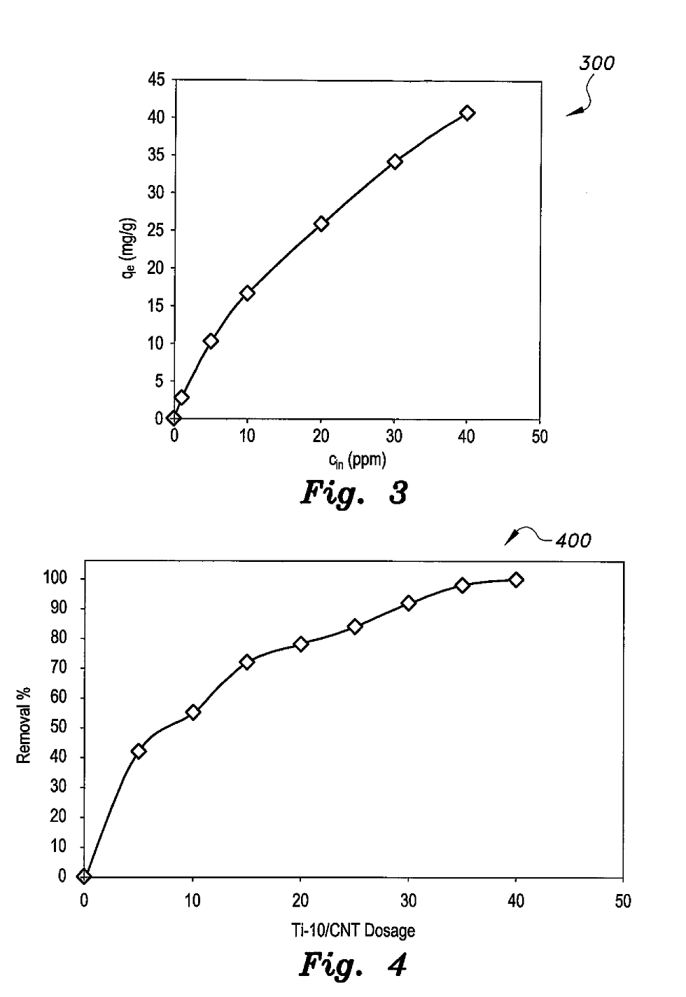

Referring to FIG. 3, the effects of the initial concentration of Se on the adsorption capacity of Ti/CNTs are shown as plot 300. The parameters of this experiment included an agitation speed of 150 rpm, a pH value of 6, a dosage of 10 mg of Ti-10/CNTs, and a contact time of 6 hrs. The adsorption capacity of the Ti-10/CNTs embodiment was increased by increasing the initial concentration of Se. This result was due to increasing the driving force of mass transfer of Se ions towards the Ti-10/CNTs surface. As shown by plot 300, the highest equilibrium adsorption capacity (qₑ) was about 41 mg/g (mg of selenium adsorbed per g of Ti-10/CNTs) at an initial Se concentration of 40 ppm.

Referring to FIG. 4, the effects of Ti-10/CNTs dosage on Se removal percentage are shown in plot 400. These batch adsorption experiments were carried out by using varying dosages of Ti-10/CNTs. Dosages varied from 5 mg to 40 mg, while other parameters were fixed with the pH, contact time, and agitation speed fixed at 6, 120 minutes (mins), and 150 rpm, respectively. Se ions were completely removed from the solution by using only 40 mg of Ti-10/CNTs, as shown in plot 400.

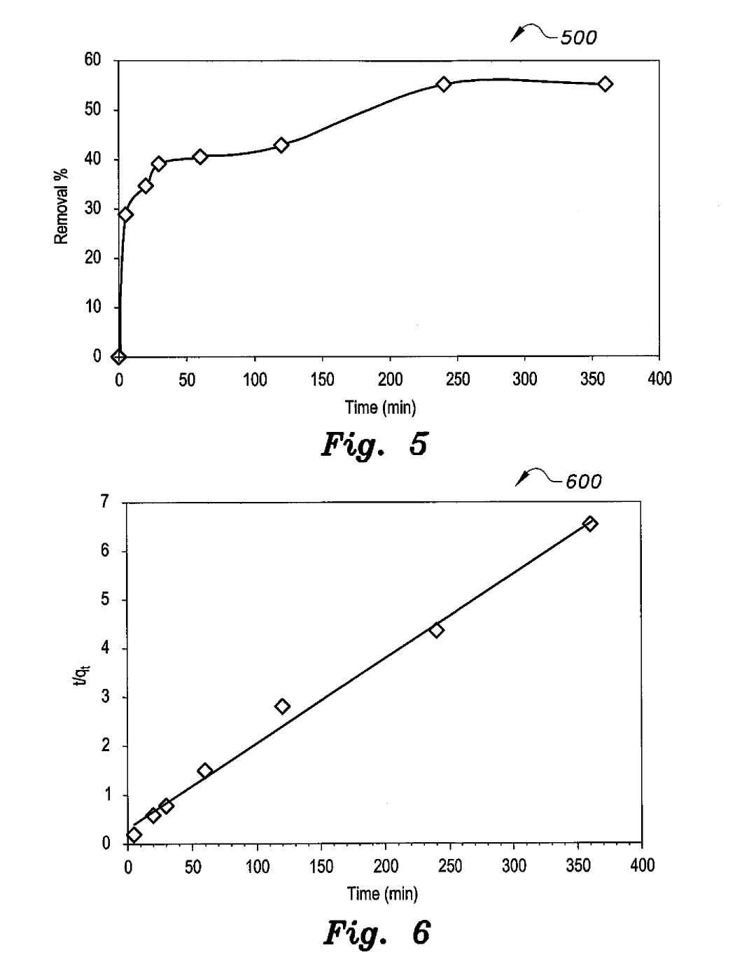

Referring to FIG. 5, the effects of contact time on Se removal percentage are shown as plot 500. The parameters of this experiment included an agitation speed of 150 rpm, a pH value of 6, a 10 mg dosage of Ti-10/CNTs, and an initial concentration of Se ions at 1 ppm. As shown by plot 500, Se adsorption was rapid during the first 30 minutes, reaching about 40 percent removal. However, Se adsorption increased only slightly after 30 minutes. Maximum removal of selenium at 55% occurred within four hours.

Referring to FIG. 6, pseudo second-order kinetics of Se is shown in plot 600. The parameters included an agitation speed of 150 rpm, a pH value of 6, a 10 mg dosage of Ti-10/CNTs, and an initial Se ions concentration of 1 ppm. The plot of t/qₜ versus time (t) yielded good straight lines (R²=0.992). The second-order rate constant (K₂) obtained was 1.2 (g·mg⁻¹·h⁻¹).

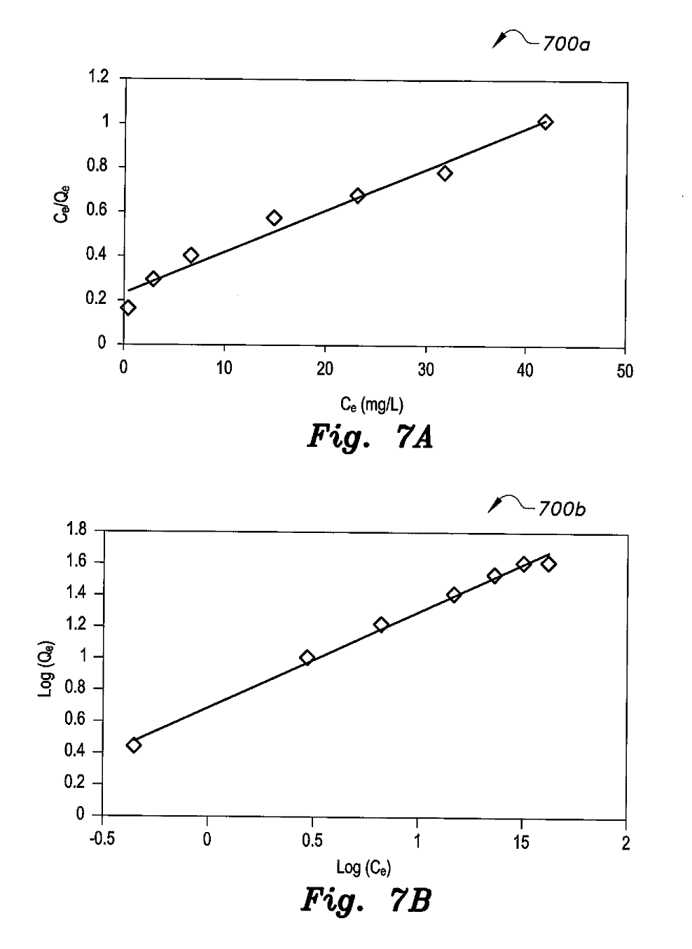

Referring to FIGS. 7A and 7B, plot 700a shows the Langmuir adsorption isotherm model of Se, and plot 700b shows the Freundlich adsorption isotherm model of Se. Further, Table 1 below shows the parameters of the Langmuir and the Freundlich adsorption isotherm models of Se.

TABLE 1
Parameters of Langmuir and Freundlich adsorption
isotherm models of Se

| Langmuir | | | Freundlich | | |
|---|---|---|---|---|---|
| qₘ | K_{L} | | | K_{F} | |
| (mg/g) | (Lmg⁻¹) | R² | n | (mg^{(1-1/n)}L^{1/n}g⁻¹) | R² |
| 55.56 | 0.078 | 0.972 | 1.647 | 4.89 | 0.992 |

Table 1 shows the parameters of the Langmuir and the Freundlich adsorption isotherm models of Se. The maximum adsorption capacity of Ti-10/CNT is 55.56 (mg/g). Therefore, it was verified that CNTs have a relatively great potential to be excellent adsorbents for the removal of selenium ions in water treatment.

It is to be understood that the present invention is not limited to the embodiments described above, but encompasses any and all embodiments within the scope of the following claims.

We claim:

1. A method for removing selenium from water, comprising the step of placing carbon nanotubes impregnated with titanium into contact with an aqueous solution of selenium in order to adsorb the selenium onto the nanotubes.

2. The method for removing selenium from water according to claim 1, further comprising the step of adjusting the pH of the aqueous solution to between a pH of 1 and a pH of 4.

3. The method for removing selenium from water according to claim 1, further comprising the step of adjusting the pH of the water to about 1.

4. The method for removing selenium from water according to claim 1, wherein the titanium-impregnated carbon nanotubes comprise about 5 weight (wt) % titanium.

5. The method for removing selenium from water according to claim 1, wherein the titanium-impregnated carbon nanotubes comprise about 10 wt % titanium.

6. The method for removing selenium from water according to claim 1, wherein the titanium-impregnated carbon nanotubes comprise about 20 wt % titanium.
